(19) United States
(12) Patent Application Publication
(10) Pub. No.: US 2010/0207962 A1
(43) Pub. Date: Aug. 19, 2010

(54) Image data transmission from GPU to system memory

(75) Inventors: Torin Taerum, Calgary (CA); Monroe M. Thomas, Calgary (CA); Michael Beauregard, Calgary (CA); Derek Scherger, Calgary (CA)

Correspondence Address: Frank J. Bonini, Jr.;Harding, Earley, Follmer, Frailey, PC, 86 The Commons at Valley Forge East, 288 Valley Forge Road, Post Office Box 750, Valley Forge, PA, 19482-0750, US

(73) Assignee: Calgary Scientific Inc., Calgary (CA)

(21) Appl. No.: 12/658,058

(22) Filed: Feb. 1, 2010

Related U.S. Application Data
(60) Provisional application No. 61/202,148, filed on Feb. 2, 2009.

(51) Int. Cl. G09G 5/00

(52) U.S. Cl. 345/634

(57) ABSTRACT

A method for transmitting image data sets is provided. At a first location of a computer system image difference data are determined by performing a differencing operation between corresponding pixels of a first image and second image. The first image and the second image are divided into sub regions. Sub region difference data are determined in dependence upon the sub regions and the image difference data. The sub region difference data are indicative of sub regions having same pixel values in the first and the second image and are indicative of sub regions having at least a different pixel value in the first and the second image. Image data in dependence upon the sub region difference data are transmitted to a second location of the computer system. The image data correspond to sub regions having at least a different pixel value in the first and the second image. At the second location the image data are replaced in the respective sub regions of the first image retrieved from storage at the second location.

### CROSS-REFERENCE TO RELATED APPLICATION

This application claims the benefit of U.S. Provisional Patent Application No. 61/202,148 filed Feb. 2, 2009, the entire contents of which are incorporated herein by reference.

### FIELD OF THE INVENTION

The instant invention relates to image data processing using a Graphic Processing Unit (GPU) and in particular to a method and system for reducing bandwidth used to transmit the image data from the GPU to system memory.

### BACKGROUND

Modern hospitals utilize medical images from a variety of imaging devices such as, for example, a Computer Tomography (CT) scanner or a Magnetic Resonance Imaging (MRI) scanner. The image data are then stored and processed using a computer to enable medical professionals to view and diagnose the captured medical images.

Present day imaging devices provide images with ever increasing resolution and facilitating or even enabling medical professionals' diagnostic capability. This improvement in resolution results in a substantial increase of the size of the image data, in particular for diagnostic quality medical images. The increase in the size of the image data is accompanied by substantially increased processing speed of computers and workstations—and in particular GPUs—for processing and displaying of the image data.

Unfortunately, this development is not accompanied by a similar increase in transmission speed for transmitting the image data, for example, from the GPU to system memory via a system bus for rendering images to a non-video memory. For example, for large image data sets of diagnostic quality medical images transfer time for transmitting the image data between the GPU and system memory is too long to be useful for many user interactive applications.

It would be desirable to provide a method and system for reducing bandwidth used to transmit the image data from the GPU to system memory.

### SUMMARY OF EMBODIMENTS OF THE INVENTION

In accordance with embodiments of the present invention there is provided a method for transmitting image data sets. At a first location of a computer system data indicative of a first image and data indicative of a second image are provided. At a second location of the computer system data indicative of the first image are also provided. The second location is connected to the first location via a data communication link. Using a first processor the first image and the second image are divided into sub regions in a same fashion. Using the first processor image difference data are determined by performing a differencing operation between corresponding pixels of the second image and the first image. Using the first processor sub region difference data are determined in dependence upon the sub regions and the image difference data. The sub region difference data are indicative of sub regions having substantially same pixel values in the first and the second image and are indicative of sub regions having at least a different pixel value in the first and the second image. Using the first processor image data in dependence upon the sub region difference data are transmitted to the second location of the computer system. The image data correspond to sub regions having at least a different pixel value in the first and the second image. Using a second processor at the second location the image data are replaced in the respective sub regions of the first image.

In accordance with embodiments of the present invention there is yet further provided a storage medium having stored therein executable commands for execution on at least a processor of a computer system, the at least a processor when executing the commands provides at a first location of a computer system data indicative of a first image and data indicative of a second image. The at least a processor provides at a second location of the computer system data indicative of the first image. The second location is connected to the first location via a data communication link. The at least a processor divides the first image and the second image into sub regions in a same fashion and determines image difference data by performing a differencing operation between corresponding pixels of the second image and the first image. The at least a processor determines sub region difference data in dependence upon the sub regions and the image difference data. The sub region difference data are indicative of sub regions having substantially same pixel values in the first and the second image and are indicative of sub regions having at least a different pixel value in the first and the second image. The at least a processor transmits image data in dependence upon the sub region difference data to the second location of the computer system. The image data corresponding to sub regions have at least a different pixel value in the first and the second image. The at least a processor replaces at the second location the image data in the respective sub regions of the first image.

### BRIEF DESCRIPTION OF THE FIGURES

Exemplary embodiments of the invention will now be described in conjunction with the following drawings, in which:

FIG. 1 is a simplified block diagram of a system for implementing the method for transmitting image data sets according to an embodiment of the invention; and,

FIG. 2 is a simplified flow diagram of embodiments of a method for accessing transmitting image data sets according to the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Unless defined otherwise, all technical and scientific terms used herein have the same meaning as commonly understood by one of ordinary skill in the art to which the invention belongs.

While embodiments of the invention will be described for medical image data transmission between a GPU and system memory for the sake of simplicity, it will become evident to those skilled in the art that the embodiments of the invention are not limited thereto, but are applicable in numerous other fields where large data sets are transmitted between a GPU and system memory. Furthermore, while the embodiments of the invention will be described for the transmission of 2D image datasets for the sake of simplicity, they are not limited thereto but are also applicable for the transmission of 3D datasets and higher dimensional datasets.

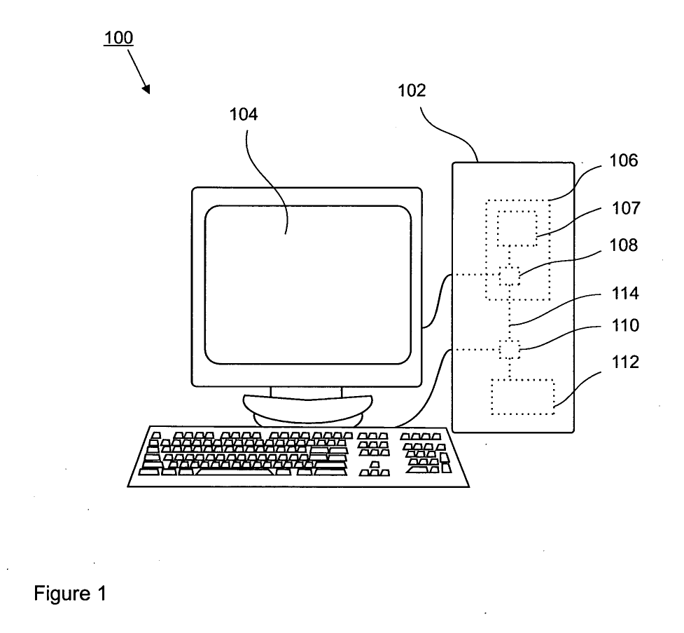

Referring to FIG. 1, an example 100 of a system for implementing a method for transmitting image data sets according to embodiments of the invention described herein below is shown. The system comprises, for example, a workstation 102 for rendering images using a GPU 106. For example, a medical practitioner is rendering images from a volume dataset for performing a diagnosis. During the rendering process the medical practitioner interacts with the GPU for determining different images corresponding to different views of the volume dataset which are displayed on monitor 104. Typically, images are then stored in non-video memory outside the GPU 106 such as, for example, system memory 112. The method for transmitting image data sets according to embodiments of the invention described herein below enables transmission of large size images such as, for example, diagnostic quality medical images from the GPU 106 to the system memory 112 via, for example, a system bus 114 at transmission times which are useful for numerous interactive processes. It will become evident to those skilled in the art that the embodiments of the invention described herein below are not limited thereto, but are also applicably in numerous other systems such as client-server systems connected via a communication network such as, for example, a Local Area Network (LAN), Wide Area Network (WAN) or the Internet, as well as for transmitting numerous types of image data sets other than medical image data sets.

The method for transmitting image data sets according to embodiments of the invention is based on the concept that in an image sequence—for example, generated in successive image rendering passes—parts of successive images do not change.

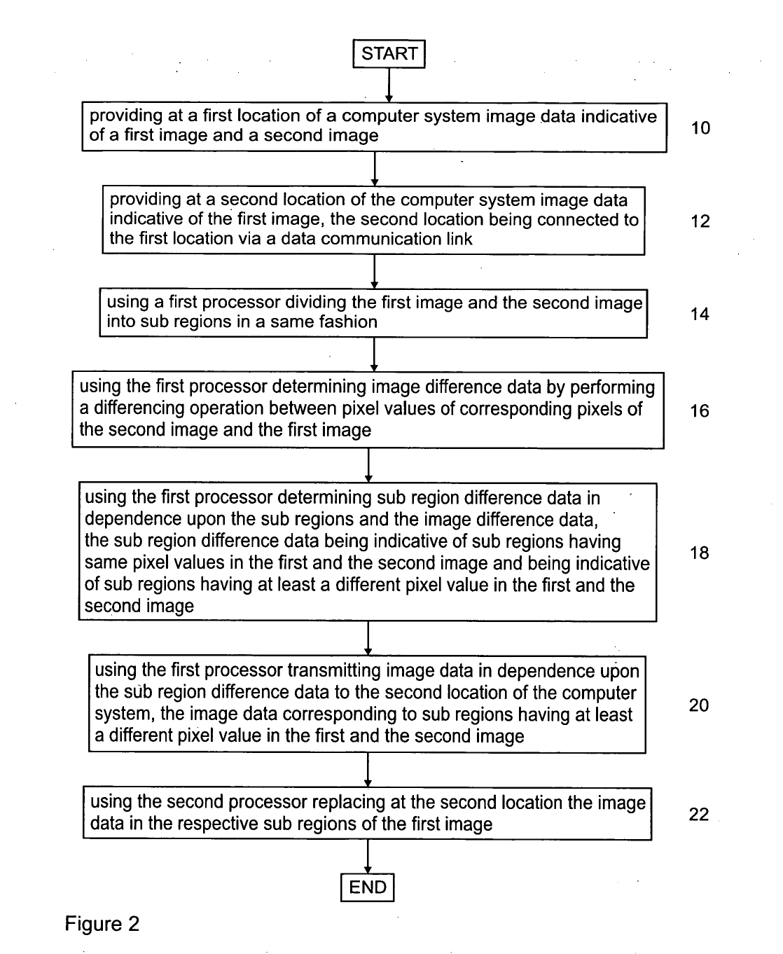

Referring to FIG. 2, a simplified flow diagram of a method for transmitting image data sets according to a preferred embodiment of the invention is shown. At 10, image data indicative of a first image and image data indicative of a second image are provided at a first location—memory 107 of the GPU 106—of the computer system 102 and—12—image data indicative of the first image are provided at a second location—the system memory 112 connected to the GPU 106 via the system bus 114.

The first image stored in the memory 107 is the last transmitted image —a copy of a rendered image that has been most recently transmitted to the system memory 112. The second image stored in the memory 107 is the rendered image—containing the result of the most recent rendering operation—that is to be transmitted to the system memory 112. The first image stored in the system memory 112 is the host image. The host image, the last transmitted image and the rendered image have the same pixel dimensions W×H. Initially, the pixels of the host image and the last transmitted image are, for example, set to be black. Alternatively, all pixels are set to a same color other than black or to different colors for different pixels.

Using processor 108 of the GPU 106 the first image—i.e. the last transmitted image—and the second image —i.e. the rendered image—are divided into sub regions in a same fashion—14—and image difference data are determined—16—by performing a differencing operation between pixel values of corresponding pixels of the second image and the first image. For example, a difference mask image is determined that holds the result of the differencing operation between the rendered image and the last transmitted image. A value of a pixel of the difference mask image is set to zero if the corresponding pixels have a same value. Alternatively, the value is set to zero if the corresponding pixels have a value that is similar within a predetermined range. Each of the rendered image, the last transmitted image, and the difference mask image are divided into discrete sub regions or “tiles” of pixel dimension w×h, where w is the width of the tile of a size not less than one and not greater than the width W of the image, and h is the height of the tile of a size not less than one and not greater than the Height H of the image. In case the dimensions of the tile do not evenly divide the dimensions of the image, the dimension of some of the tiles is less than w×h. Alternatively, sub regions of various dimensions are employed. The tile dimensions are, for example, predetermined fixed values. Optionally, the tile dimensions are adjusted between transmissions of successive images such that, for example, the number of transmitted pixel values is reduced.

Using the processor 108 of the GPU 106 sub region difference data are determined—18—in dependence upon the sub regions—tiles—and the image difference data. The sub region difference data are indicative of sub regions having same pixel values in the first image—the last transmitted image—and the second image—the rendered image—and are indicative of sub regions having at least a different pixel value in the first and the second image. For example, the sub region difference data are forming a tile difference image of pixel dimension n×m, where each pixel has a one-to-one relationship with a sub region—tile of the difference mask image. A pixel value in the tile difference image is zero if the pixel values of all pixels in the corresponding tile of the difference mask image are zero. The data indicative of the tile difference image are stored, for example, in the memory 107 of the GPU 106.

Optionally, the tile difference image is determined directly obviating generation and use of the difference mask image. In this case, a pixel value in the tile difference image is zero if all corresponding pixels in the corresponding tiles of the rendered image and the last transmitted image have same pixel values.

Using the processor 108 of the GPU 106 image data are transmitted—20—in dependence upon the sub region difference data to the second location—system memory 112—of the computer system 102. The image data correspond to sub regions having at least a different pixel value in the first and the second image. For example, for each pixel in the tile difference image that is non-zero the image data of the corresponding tile of the rendered image are transmitted via the system bus 114 to processor 110 of the computer system 102.

Using processor 110 the image data are replaced—22—in the respective sub regions of the first image retrieved from the memory 112, i.e. the image data of corresponding tiles in the host image are replaced by the transmitted image data of the rendered image.

Finally, the image data of the last transmitted image stored in the memory 107 are replaced by the image data of the rendered image.

In an embodiment of the method for transmitting image data sets according to the invention the rendered image, the last transmitted image and the host image each are divided into color component images—for example, Red, Green, and Blue (RGB). Each color component image is then processed as disclosed above with respect to FIG. 2 resulting in three color component images which are then superposed to produce the host image. Alternatively, other color component decompositions are employed such as, for example, YUV, CMYK, or HSL.

The embodiments of the method for transmitting image data sets according to the invention are performed, for example, by executing executable commands stored in a storage medium—for example, the memory 107 and/or system memory 112—using processor 108 and/or processor 114. Alternatively, the above steps are executed in a hardware implemented fashion.

The present invention has been described herein with regard to preferred embodiments. However, it will be obvious to persons skilled in the art that a number of variations and modifications can be made without departing from the scope of the invention as described herein.

What is claimed is:

1. A method comprising:
providing at a first location of a computer system data indicative of a first image and data indicative of a second image;
providing at a second location of the computer system data indicative of the first image, the second location being connected to the first location via a data communication link;
using a first processor dividing the first image and the second image into sub regions in a same fashion;
using the first processor determining image difference data by performing a differencing operation between corresponding pixels of the second image and the first image;
using the first processor determining sub region difference data in dependence upon the sub regions and the image difference data, the sub region difference data being indicative of sub regions having substantially same pixel values in the first and the second image and being indicative of sub regions having at least a different pixel value in the first and the second image;
using the first processor transmitting image data in dependence upon the sub region difference data to the second location of the computer system, the image data corresponding to sub regions having at least a different pixel value in the first and the second image; and,
using a second processor replacing at the second location the image data in the respective sub regions of the first image.

2. A method as defined in claim 1 comprising:
using the first processor replacing the data indicative of the first image with the data indicative of the second image.

3. A method as defined in claim 1 comprising:
using the first processor determining a difference mask image in dependence upon the image difference data wherein pixel values of zero indicate a same pixel value of corresponding pixels in the first and the second image.

4. A method as defined in claim 1 comprising:
using the first processor determining a difference mask image in dependence upon the image difference data wherein pixel values of zero indicate a pixel value of corresponding pixels in the first and the second image that is similar within a predetermined range.

5. A method as defined in claim 1 wherein the differencing operation comprises determining a difference between pixel values of the corresponding pixels.

6. A method as defined in claim 1 wherein the sub regions have predetermined fixed dimensions.

7. A method as defined in claim 1 wherein the sub regions are adjusted between transmissions of successive images.

8. A method as defined in claim 1 wherein the first location is a Graphic Processing Unit and the first processor is a processor of the Graphic Processing Unit.

9. A storage medium having stored therein executable commands for execution on at least a processor of a computer system, the at least a processor when executing the commands performing:
providing at a first location of a computer system data indicative of a first image and data indicative of a second image;
providing at a second location of the computer system data indicative of the first image, the second location being connected to the first location via a data communication link;
dividing the first image and the second image into sub regions in a same fashion;
determining image difference data by performing a differencing operation between corresponding pixels of the second image and the first image;
determining sub region difference data in dependence upon the sub regions and the image difference data, the sub region difference data being indicative of sub regions having substantially same pixel values in the first and the second image and being indicative of sub regions having at least a different pixel value in the first and the second image;
transmitting image data in dependence upon the sub region difference data to the second location of the computer system, the image data corresponding to sub regions having at least a different pixel value in the first and the second image; and,
replacing at the second location the image data in the respective sub regions of the first image.
